(19) United States
(12) Patent Application Publication
(10) Pub. No.: US 2015/0299535 A1
(43) Pub. Date: Oct. 22, 2015

(54) HOT-MELT PRESSURE-SENSITIVE ADHESIVE FOR A RECLOSABLE PACKAGING HAVING IMPROVED ORGANOLEPTIC PROPERTIES

(71) Applicant: BOSTIK SA, La Plaine St Denis (FR)

(72) Inventor: Christophe ROBERT, Thourotte (FR)

(73) Assignee: BOSTIK SA, La Plaine St Denis (FR)

(21) Appl. No.: 14/418,510

(22) PCT Filed: Jul. 25, 2013
(86) PCT No.: PCT/FR2013/000205

§ 371 Date: Jan. 30, 2015

(30) Foreign Application Priority Data
Jul. 30, 2012 (FR) 1257353

(51) Int. Cl. C09J 153/02; B32B 27/08; B32B 27/18; B29D 7/01; C08K 3/34; C09J 153/00; B29C 47/06; B29C 47/00; B32B 7/12; B32B 27/30

(52) U.S. Cl. CPC C09J 153/02; B32B 7/12; B32B 27/08; B32B 27/18; B32B 27/302; C08K 3/34; C09J 153/00; B29C 47/065; B29C 47/0004; B29D 7/01; B32B 2439/40; B32B 2439/70; B32B 2250/03; B29K 2105/0097

(57) ABSTRACT

1. Hot-melt pressure-sensitive adhesive composition with an MFI of 0.01 to 100 g/10 minutes comprising:
from 40% to 70% of a mixture of styrene block copolymers of SIS type with a styrene content of 10% to 40% and a diblock content of 30% to 90%,
from 25% to 55% of a tackifying resin with a softening point of between 5 and 140° C., and
from 0.1% to 5% of a hydrophobic zeolite consisting of a hydrated alkali metal or alkaline-earth metal aluminosilicate in which the Si/Al mole ratio is in the range from 5 to 1000.

2. Multilayer film comprising a layer with a thickness of between 7 and 300 μm consisting of said composition.

3. Process for manufacturing said film by coextrusion.

4. Use of said film for manufacturing reclosable trays.

The present invention relates to a novel extrudable hot-melt pressure-sensitive adhesive composition for manufacturing reclosable packagings (or trays). The invention also relates to a multilayer film which comprises an adhesive layer consisting of said composition, and which has improved organoleptic properties.

Extrudable hot-melt pressure-sensitive adhesive compositions intended to be used for manufacturing reclosable packagings (or trays) are known especially from patent applications WO 02/064 694, WO 12/045 950 and WO 12/045 951.

Reclosable trays are used in the agrifood industry and in mass retailing for packaging foodstuffs, especially fresh products. Such packagings are described in U.S. Pat. No. 4,673,601 and patent application EP 1 053 952.

After a first opening of the packaging and consumption of some of the food product it contains, the user can manually reclose the packaging in a substantially hermetic manner and thus ensure, where appropriate after placing it in a refrigerator, conservation of the remaining portion of the product. Reopening and reclosing a number of times is also possible.

These packagings generally comprise a container (or receptacle) and a cover forming a lid, which are fixed together hermetically by welding.

The receptacle, which is more or less deep and relatively rigid, consists of a multilayer sheet (also known as a complex or composite) with a minimum thickness of 200 μm, generally between 200 and 1000 μm. This sheet is thermoformed so as to have a flat base on which the food product rests and a perimeter in the form of a flat strip. This perimeter, which is generally parallel to the base, is connected by welding to the cover, flexible and flat, which consists of a multilayer film (also known as a complex or composite) generally with a thickness of between 40 and 150 μm, and which is occasionally referred to as a cover film.

During the opening of the packaging, the cover film is manually separated from the receptacle at the flat strip of the perimeter. This operation exposes an adhesive layer at this flat strip, both on the cover strip and on the receptacle strip that were previously in contact. These two adhesive layers (continuous or discontinuous) known as “daughters” result from the breaking of an initial adhesive layer or “mother” layer or, optionally, from its separation (or detachment) from one of the two layers of the complex multilayer film that are adjacent thereto. The initial adhesive layer is thus one of the layers of said complex multilayer film, which is itself an element included either in the composite sheet which constitutes the receptacle or, optionally, in the cover film.

The two daughter adhesive layers that are present, after opening the packaging, on the strips located on the respective perimeter of the receptacle and of the cover are therefore facing each other. Thus, it suffices to reposition the cover on the receptacle, in accordance with their position in the packaging before opening, in order to put the two strips of daughter adhesive layers in contact again. A simple manual pressure then makes it possible to obtain reclosure of the packaging.

The adhesive composition that constitutes the mother and daughter adhesive layers is thus necessarily a pressure-sensitive adhesive (PSA).

The extrudable pressure-sensitive adhesive compositions described in the abovementioned applications are hot-melt compositions comprising a tackifying resin and a styrene block copolymer including an elastomeric block. They are substances that are solid at room temperature, which contain neither water nor solvent. When applied in the molten state, they solidify on cooling, thus forming an adhesive layer that provides bonding between the two thin layers of thermoplastic polymer material to be assembled, while at the same time affording the corresponding packaging the advantageous properties of opening and of reclosing.

Moreover, these hot-melt pressure-sensitive adhesive compositions, which are prepared by hot mixing of their ingredients, also have the advantage of being able to be placed in the form of granules (between 1 and 10 mm in size) by means of an extrusion step performed directly while hot after the mixing step, for example using a twin-screw extruder equipped with a tool for chopping the extruded product.

By means of the granules thus obtained, the three-layer film consisting of the layer of hot-melt pressure-sensitive adhesive composition and of the two thin layers of thermoplastic polymer material to be assembled may be conveniently manufactured by coextrusion, for example by feeding a film blowing device with the constituent materials of the three layers in the form of granules having the size defined previously.

However, in the context of the ongoing improvement of packagings for food products proposed by the industry to consumers, it now appears increasingly necessary to envision the impact of said packagings on a possible impairment of the organoleptic properties of the packaged foodstuffs, and especially on a risk of impairment of their taste and/or odor (or fragrance), most particularly in the case of hermetic packagings.

As regards hot-melt pressure-sensitive adhesive compositions for reclosable packagings known in the prior art, it is considered that this impact may result from the presence in said compositions of very small amounts—ranging up to a maximum limit of 5 ppm—of volatile organic compounds of low molar mass (less than 1000 Da) which originate from the impurities present in the starting materials: for example, residues of the monomers or oligomers that are used in the polymerization reactions of the styrene block copolymers or tackifying resins.

It is therefore not possible to set aside the risk that, in the final packaging, volatile organic compounds present in trace amount in the hot-melt pressure-sensitive adhesive composition migrate through the layers of thermoplastic materials of the complex film to penetrate into the foodstuff, and modify the organoleptic properties thereof. This risk may be all the less set aside if it is considered that certain persons who are very sensitive to olfactory and/or gustatory sensations are capable of detecting traces down to 1 ppb of certain substances.

Patent application WO 01/10966 describes an adhesive composition comprising a polymer and a hydrophobic zeolite with a pore diameter of greater than 4 Angstroms, for eliminating the undesirable odors or aromas thereof. However, this adhesive composition is water-based and is unsuitable for the manufacture by hot extrusion of the three-layer film mentioned previously.

The aim of the present invention is to propose an extrudable hot-melt pressure-sensitive adhesive composition which makes it possible cumulatively:
to bond in a three-layer film two thin layers of thermoplastic materials, while at the same time affording these two layers opening and reclosing properties, intrinsic to the use of said film for manufacturing a reclosable packaging,
to manufacture said three-layer film via an industrial process of hot coextrusion of the constituent materials of each layer in the form of granules, and
to reduce the risk of impairment of the organoleptic properties of the packaged foodstuff, and more particularly of its taste.

A subject of the invention is thus, firstly, a hot-melt pressure-sensitive adhesive composition having a melt flow index (or MFI) ranging from 0.01 to 100 g/10 minutes and comprising:
from 40% to 70% of a mixture a) of styrene block copolymers comprising at least one elastomeric block, this mixture a) consisting of:
   from 30% to 90% by weight of at least one diblock copolymer chosen from the group comprising SI, SBI, SIB, SB, SEB and SEP, and
   from 10% to 70% by weight of at least one triblock copolymer chosen from the group comprising SIS, SIBS, SBS, SEBS and SEPS;
   the total content of styrene units in said mixture a) ranging from 10% to 40% by weight;
from 25% to 55% of one or more tackifying resins b) with a softening point of between 5 and 140° C.; and
from 0.1% to 5% of a hydrophobic zeolite c) consisting of a hydrated aluminosilicate of an alkali metal or alkaline-earth metal in which the Si/Al mole ratio is in the range from 5 to 1000;

the percentages of ingredients a), b) and c) being expressed by weight and relative to the total weight of the pressure-sensitive adhesive composition.

Besides these percentages, all the percentages generally used in the present text to denote the amounts of ingredients correspond, unless otherwise indicated, to weight/weight percentages.

According to one embodiment, the hot-melt pressure-sensitive adhesive composition consists essentially:
from 40% to 70% of a mixture a) of styrene block copolymers comprising at least one elastomeric block, this mixture a) consisting of:
   from 30% to 90% by weight of at least one diblock copolymer chosen from the group comprising SI, SBI, SIB, SB, SEB and SEP, and
   from 10% to 70% by weight of at least one triblock copolymer chosen from the group comprising SIS, SIBS, SBS, SEBS and SEPS;
   the total content of styrene units in said mixture a) ranging from 10% to 40% by weight;
from 25% to 55% of one or more tackifying resins b) with a softening point of between 5 and 140° C.; and
from 0.1% to 5% of a hydrophobic zeolite c) consisting of a hydrated aluminosilicate of an alkali metal or alkaline-earth metal in which the Si/Al mole ratio is in the range from 5 to 1000;

the percentages of ingredients a), b) and c) being expressed by weight and relative to the total weight of the pressure-sensitive adhesive composition.

The melt flow index (or MFI) is measured at 190° C. and for a total weight of 2.16 kg, in accordance with condition d) of standard ISO 1133. The MFI is the mass of composition (placed beforehand in a vertical cylinder) which flows over 10 minutes through a die of fixed diameter, under the effect of a pressure exerted by a loaded piston having a total weight of 2.16 kg. Unless otherwise mentioned, the MFI values indicated in the present text were measured under these same conditions.

Hot-melt pressure-sensitive adhesive compositions with an MFI ranging from 2 to 70 g/10 minutes are more particularly preferred.

According to another embodiment, the water content of the hot-melt pressure-sensitive adhesive composition according to the invention is less than 1%, preferably 0.5% and even more preferentially less than 0.1%.

Description of the Mixture a) of Styrene Block Copolymers:

The styrene block copolymers included in mixture a) consist of various polymerized monomers, including at least one polystyrene block, and are prepared via radical polymerization techniques. The triblock copolymers include two polystyrene blocks and one elastomeric block. They may include various structures: linear, star (also known as radial), branched or comb. The diblock copolymers include one polystyrene block and one elastomeric block.

The styrene block copolymers that may be used in the pressure-sensitive adhesive composition according to the invention have a weight-average molar mass Mw generally between 50 kDa and 500 kDa and consist of blocks of various polymerized monomers. Unless otherwise indicated, the weight-average molar masses M_{w} that are given in the present text are expressed in daltons (Da) and are determined by gel permeation chromatography, the column being calibrated with polystyrene standards.

The triblock copolymers have the general formula:

ABA (I)

in which:
A represents a styrene (or polystyrene) non-elastomeric block, and
B represents an elastomeric block which may be:
   polyisoprene. The block copolymer then has the structure: polystyrene-polyisoprene-polystyrene, and has the name: SIS;
   polyisoprene followed by a polybutadiene block. The block copolymer then has the structure: polystyrene-polyisoprene-polybutadiene-polystyrene, and has the name: SIBS;
   polybutadiene. The block copolymer then has the structure: polystyrene-polybutadiene-polystyrene, and has the name: SBS;
   totally or partially hydrogenated polybutadiene. The block copolymer then has the structure: polystyrene-poly(ethylene-butylene)-polystyrene, and has the name: SEBS;
   totally or partially hydrogenated polyisoprene. The block copolymer then has the structure: polystyrene-poly(ethylene-propylene)-polystyrene, and has the name: SEPS.

The diblock copolymers have the general formula:

A-B (II)

in which A and B are as defined previously.

When mixture a) included in the pressure-sensitive adhesive composition comprises several triblock styrene copolymers, the latter being chosen from the group comprising SIS, SBS, SEPS, SIBS, SEBS, it is clearly understood that said triblocks may belong to a single family or to several of these five families of copolymers. This is likewise the case, mutatis mutandis, for the diblock copolymers.

It is preferred to use a mixture a) of a triblock copolymer and of a diblock copolymer having the same elastomeric block, on account especially of the fact that such mixtures are commercially available.

According to another embodiment variant, the content of diblock copolymer in mixture a) may range from 50% to 90%, preferably from 50% to 80% and even more preferentially from 55% to 80%.

According to a particularly advantageous embodiment of the hot-melt pressure-sensitive adhesive composition according to the invention, a) is a mixture of an SIS triblock copolymer and of an SI diblock copolymer. In this case, the total content of styrene units in mixture a) preferably ranges from 15% to 20%.

According to another embodiment that is also advantageous of the hot-melt pressure-sensitive adhesive composition according to the invention, a) is a mixture of an SBS triblock copolymer and of an SB diblock copolymer. In this case, the total content of styrene units in mixture a) advantageously ranges from 20% to 35%.

The triblock copolymers included in the pressure-sensitive adhesive composition preferably have a linear structure.

The styrene block copolymers bearing an elastomeric block, especially of SI and SIS type, which may be used in mixture a) are commercially available, often in the form of triblock/diblock mixtures.

Kraton® D1113BT from the company Kraton and Quintac 3520 from the company Zeon Chemicals are examples of mixtures a) of SIS and SI.

Kraton® D1113BT is a mixture in which the overall content of styrene units is 16%, and which consists of 45% of linear SIS triblock copolymer with an M_{w} of about 250 kDa, and 55% of SI diblock copolymer with an M_{w} of about 100 kDa. Quintac® 3520 is a mixture which consists, respectively, of 22% and 78% of SIS triblock (M_{w} about 300 kDA) and of SI diblock (M_{w} about 130 kDa), and in which the total content of styrene units is 15%.

Description of the Tackifying Resin b):

The tackifying resin(s) that may be used in the pressure-sensitive adhesive composition according to the invention have weight-average molar masses M_{w} generally between 300 and 5000 Da and are chosen especially from:
(i) rosins of natural or modified origin, for instance rosin extracted from pine gum, wood rosin extracted from tree roots and derivatives thereof that have been hydrogenated, dehydrogenated, dimerized, polymerized or esterified with monoalcohols or polyols such as glycerol;
(ii) resins obtained by hydrogenation, polymerization or copolymerization (with an aromatic hydrocarbon) of unsaturated aliphatic hydrocarbon mixtures containing about 5, 9 or 10 carbon atoms derived from petroleum fractions;
(iii) terpene resins generally resulting from the polymerization of terpene hydrocarbons, for instance monoterpene (or pinene) in the presence of Friedel-Crafts catalysts, optionally modified via the action of phenols;
(iv) copolymers based on natural terpenes, for example styrene/terpene, α-methylstyrene/terpene and vinyltoluene/terpene.

The softening temperature (or point) of the tackifying resins that may be used in the composition according to the invention may range from 5 to 140° C. The softening point is determined in accordance with the standardized test ASTM E 28, the principle of which is as follows. A brass ring about 2 cm in diameter is filled with the resin to be tested in molten form. After cooling to room temperature, the ring and the solid resin are placed horizontally in a bath of thermostatically maintained glycerol whose temperature may vary by 5° C. per minute. A steel ball about 9.5 mm in diameter is centered on the disk of solid resin. The softening point is—during the phase of temperature increase of the bath at a rate of 5° C. per minute —the temperature at which the disk of resin creeps up by 25.4 mm under the weight of the ball.

According to a preferred variant, aliphatic tackifying resins are used, and even more preferentially aliphatic resins belonging to categories (ii) or (iii) for which examples of commercially available resins that may be mentioned include:

(ii) Escorez® 1310 LC available from Exxon Chemicals, which is a resin obtained by polymerization of a mixture of unsaturated aliphatic hydrocarbons containing about 5 carbon atoms, and which has a softening point of 94° C. and an Mw of about 1800 Da; Escorez® 5400 also from the company Exxon Chemicals, which is a resin obtained by polymerization and then hydrogenation of a mixture of unsaturated aliphatic hydrocarbons containing about 9 or 10 carbon atoms and which has a softening point of 100° C. and an Mw of about 570 Da;

(iii) Dercolyte® S115 available from the company Dérivés Résiniques et Terpéniques (or DRT), which is a terpene resin with a softening point of 115° C. and an Mw of about 2300 Da.

Description of the Zeolite c):

Zeolites are microporous minerals of natural or synthetic origin which consist of hydrated alkali metal or alkaline-earth metal aluminosilicates, and which are commonly used as adsorbents or for purposes of separating mixtures of chemical compounds as molecular sieves.

In structural terms, zeolites are complex crystalline inorganic polymers, based on an undefined and three-dimensional sequence of quadri-connected structures of tetrahedral AlO₄ and SiO₄, linked together via an exchange of oxygen ions (oxide). Each tetrahedral AlO₄ present in the structure provides a strong negative charge which is counterbalanced by one or more cations of an alkali metal or alkaline-earth metal, for example Na⁺, Ca²⁺, Mg²⁺, or K³⁰ . It is these sequences of tetrahedra that generate the constituent channels and cavities of the micropores present in zeolite, in a manner specific to each zeolite structure. These micropores have a precise and uniform size, which varies according to the structure of the zeolite between 3 and 13 Å, which allows molecules of appropriate size and shape, which are generally sufficiently small, to selectively penetrate into said pores and be retained therein by adsorption on their inner wall.

It has been found that the presence in the pressure-sensitive adhesive composition according to the invention of the hydrophobic zeolite c) with an Si/Al mole ratio of between 5 and 1000 allows a significant reduction in the impairment of the taste of a food placed in contact with said composition, for which it may be conjectured that the impact is associated with the presence in said composition of traces of volatile organic compounds of low molar mass, for example less than 1000 Da.

This consequently results, a fortiori, in a significant reduction in the risk of impairment (or modification) of the taste of packaged foods during their storage, which risk is thought to be associated with these volatile organic compounds, and with their possible migration to the food, from the layer of the packaging film constituted by said composition and through the other layers of said complex film.

Moreover, it has also been found that the incorporation into the pressure-sensitive adhesive composition of the hydrophobic zeolite c) advantageously conserves the opening and reclosing properties of the corresponding three-layer film, thus making this film suitable for use for the manufacture of reclosable packaging.

The Si/Al mole ratio of zeolite c) is advantageously between 5 and 500, preferably between 5 and 100, more preferentially between 5 and 20 and even more preferentially between 5 and 15.

Even more preferably, zeolite c) consists of a hydrated sodium aluminosilicate.

Zeolite c) advantageously has a mean pore diameter of between 5 and 100 Å and is in the form of a powder of solid particles, whose median diameter is in the region of 4 μm.

Zeolites corresponding to the definition given above for zeolite c) are commercially available. Mention may thus be made of the zeolite Abscents® 2000 which is available from the company UOP and which is a hydrophobic zeolite consisting of at least 95% by weight of a hydrated sodium aluminosilicate, the Si/Al mole ratio of which is between 5 and 15.

According to a more particularly preferred embodiment, the hot-melt pres sure-sensitive adhesive composition according to the invention comprises:
from 50% to 65% of mixture a) of styrene block copolymers, even more preferentially from 55% to 65%,
from 30% to 50% of tackifying resin b), even more preferentially from 35% to 45%, and
from 0.5% to 4% of hydrophobic zeolite c), even more preferentially from 1% to 3%.

The adhesive composition may also comprise from 0.1% to 2% of one or more stabilizers (or antioxidants). These compounds are introduced to protect the composition from degradation resulting from a reaction with oxygen which is liable to be formed by the action of heat, light or residual catalysts on certain starting materials such as the tackifying resins. These compounds may include primary antioxidants which trap free radicals and are generally substituted phenols such as Irganox® 1010 from BASF. The primary antioxidants may be used alone or in combination with other antioxidants such as phosphites, for instance Irgafos® 168 also from BASF, or alternatively with UV stabilizers such as amines.

The pressure-sensitive adhesive composition may also comprise a plasticizer, but in an amount not exceeding 5%. A paraffinic and naphthenic oil (such as Primol® 352 from the company ExxonMobil) optionally comprising aromatic compounds (such as Nyflex 222B) may be used as plasticizer.

The adhesive composition may finally comprise mineral or organic fillers, pigments or dyes.

For the purpose of using it in the manufacture of a multilayer film, the adhesive composition according to the invention is preferably in the form of granules between 1 and 10 mm and preferably between 2 and 5 mm in size.

The adhesive composition may be prepared, in this form of granules, via a process comprising:
a simple step of mixing the ingredients while hot, between 150 and 200° C., preferably at about 160° C., using a twin-screw extruder equipped with a tool for chopping the extruded product at the die outlet, and then
a step of cooling, for example to room temperature.

A subject of the present invention is, secondly, a multilayer film comprising two thin layers of thermoplastic material linked together via a continuous layer, characterized in that said layer has a thickness of between 7 and 300 μm and consists of the hot-melt pressure-sensitive adhesive composition as defined previously.

According to one variant of the invention, the thickness of the binding adhesive layer is between 10 and 300 μm, preferably between 10 and 50 μm and even more preferentially between 10 and 30 μm.

Said adhesive layer allows bonding between a complexable thin layer and a sealable and splittable thin layer.

The complexable layer may be complexed (or laminated) with other layers to produce the packaging, for example with a rigid layer to make the receptacle.

The sealable and splittable layer makes it possible to provide, on the perimeter along which the receptacle is connected by welding to the cover, the first opening of the packaging, by means of a splittable weakened zone. After opening, the weakened zone exposes:
the mother adhesive layer on the cover strip and/or on the receptacle strip which were in contact in the closed packaging, and/or
two daughter adhesive layers resulting from the breaking of the mother adhesive layer and located on the cover strip and/or the receptacle strip.

The material that may be used to make the two thin layers linked together via the binding adhesive layer is generally a thermoplastic polymer (identical or different for the two layers) such as:
polyethylene (PE),
polypropylene (PP),
a copolymer based on ethylene and propylene,
polyamide (PA),
polyethylene terephthalate (PET), or
a copolymer based on ethylene, for instance a maleic anhydride grafted copolymer, a copolymer of ethylene and vinyl acetate (EVA), a copolymer of ethylene and vinyl alcohol (EVOH), a copolymer of ethylene and an alkyl acrylate such as methyl acrylate (EMA) or butyl acrylate (EBA),
polystyrene (PS),
polyvinyl chloride (PVC),
polyvinylidene fluoride (PVDF),
a lactic acid polymer (PLA), or
a polyhydroxyalkanoate (PHA).

According to one embodiment variant, the multilayer film according to the invention is a three-layer film consisting of the adhesive layer and the two adjacent layers.

According to another embodiment variant, the multilayer film according to the invention comprises, besides the two thin layers adjacent to the adhesive layer, other thin layers necessary for making the packaging, for instance:
a rigid layer necessary for the mechanical strength of the receptacle, or
a printable layer, or
a layer with a barrier effect against oxygen, water vapor or carbon monoxide.

The materials that may be used to make said layers may be identical or different and generally comprise thermoplastic polymers that may be chosen from the polymers mentioned previously for the two adjacent thin layers.

The thickness of the two thin layers adjacent to the adhesive layer and of the other layers used in the multilayer film according to the invention is liable to vary within a wide range from 5 to 150 μm.

The multilayer film according to the invention may be manufactured by depositing a suitable amount of composition according to the invention onto one of the two thin layers of material, followed by applying the second thin layer and hot-pressing. It may also be manufactured by coextrusion.

The present invention also relates to a process for manufacturing a multilayer film as defined previously, characterized in that it comprises the coextrusion of the hot-melt pressure-sensitive adhesive composition with the materials of the two adjacent thin layers.

Preferably, the hot-melt pressure-sensitive adhesive composition and the constituent materials of the two thin layers are fed into the coextrusion device in the form of granules between 1 and 10 mm and preferably between 2 and 5 mm in size. The pressure-sensitive adhesive composition used in the multilayer film according to the invention makes it possible, in a particularly advantageous manner, to provide both the properties required for said film and the possibility of presenting said composition in the form of the abovementioned granules. The other layers that may be included in the multilayer film may be obtained either by incorporating into the coextrusion device the corresponding constituent materials in the form of granules of the same size, or via a process of complexing of the film directly derived from the coextrusion.

The process of coextrusion by film blowing is more particularly preferred, especially for the manufacture of a multilayer film in which the thickness of the adhesive layer is between 7 and 50 μm, preferably between 10 and 50 μm and even more preferentially between 10 and 30 μm.

The present invention also relates to the use of the multilayer film as described previously for the manufacture of reclosable trays, preferably for the manufacture of the cover film.

The examples that follow are given purely as illustrations of the invention and cannot in any way be interpreted as limiting the scope thereof.

### EXAMPLE A (REFERENCE)

### 1. Preparation of a Hot-Melt Pressure-Sensitive Adhesive Composition

The adhesive composition indicated in the table below is prepared in the form of a viscous liquid, by simple mixing of the ingredients at 160° C. by means of a twin-screw extruder.

The measured MFI is 57 g/10 minutes.

### 2. Preparation of a Three-Layer Film

About 8 g of the adhesive composition prepared previously are placed on a square sheet of PET with a side length of 15 cm, and 50 μm thick. A second sheet of PET whose face intended to come into contact with the adhesive composition is coated with a silicone coating, and which is otherwise identical to the first sheet, is then applied.

A pressure of 100 kg/cm² is exerted on the assembly, at a temperature of 120° C. for 2 minutes, using a hydraulic press. The thickness of the layer consisting of the adhesive composition in the three-layer film obtained is controlled with slide calipers, and is found to be equal to about 250 μm.

Test for Evaluating the Impairment of the Test of Butter Placed in Contact with the Adhesive Composition

This test is performed on a slab of 125 g of butter of dimensions 110×65×17 mm.

This slab is centered horizontally on the adhesive layer of a first bilayer which is obtained by removing by peeling, from the three-layer film prepared previously, the PET sheet whose inner face, in contact with the adhesive layer, is silicone-based.

The upper face of the slab is then covered with a second bilayer identical to the first, and placed in contact with its adhesive layer.

The structure thus obtained is overwrapped in aluminum foil and then placed for 10 days in a refrigerator maintained at 10° C.

As a control, a slab of butter identical to the preceding one, which is simply wrapped in aluminum foil, is also stored in the same refrigerator for the same time.

After 10 days, the two slabs of butter are recovered, each chopped into 20 pieces of about 6 g and submitted to a panel of 10 individuals for evaluation of the taste. Each member of the panel assigns, after tasting, a note from 0 to 4 to the pieces derived from the slab placed in contact with the adhesive composition, relative to the pieces derived from the control slab, according to the following scale:
0=no perceptible difference
1=barely perceptible difference
2=slight difference
3=pronounced difference
4=strong difference.

The average note obtained is indicated in the table.

Test for Evaluating the Impairment of the Taste of Chocolate Placed in Contact with the Adhesive Composition:

This test is performed on a pack of milk chocolate of dimensions: 155×75×8 mm which is splittable into 24 identical squares, by simple repetition mutatis mutandis of the protocol described previously for the slab of butter.

The noting by the members of the panel is performed after breaking the pack of 20 squares of chocolate, by tasting the squares obtained from the pack placed in contact with the adhesive composition, relative to the squares obtained from the control pack, according to the same scale.

The average note obtained is also indicated in the table.

Measurement of the Force of First Opening by Peeling at 5° C.:

A new three-layer film identical to that prepared in point 2. previously, except that neither of the two square sheets of PET is coated with a silicone covering, is prepared.

A rectangular specimen of 1 cm by 10 cm is cut out of the film thus obtained and the 180° peel test is performed thereon. To do this, the two layers of PET film included in this strip are detached from one of the two ends of this specimen, and on about 2 cm, and the two free ends obtained are attached to two attachment devices (known as jaws) connected, respectively, to a fixed part and a mobile part of a traction machine which are located on a vertical axis.

While a drive mechanism communicates to the mobile part a uniform speed of 100 mm/minute, leading to detachment of the two layers of PET, the detached ends of which move gradually along a vertical axis forming an angle of 180°, a force sensor connected to said mobile part measures the force supported by the specimen thus maintained. The assembly consisting of the specimen, the fixed jaw and the mobile jaw to which it is attached, is placed in a chamber thermostatically maintained at a temperature of 5° C., such that the detachment is performed after stabilization at this temperature.

A result of 36 N/cm is obtained.

Measurement of the Force of Second Opening by Peeling at 5° C.:

The two layers of PET of the preceding specimen are, after their detachment, repositioned facing each other and placed in contact manually. They are then subjected to a pressure exerted by means of a roller with a mass of 2 kg with which a to-and-fro motion is effected along a direction parallel to the length of the specimen.

The preceding peeling test is then repeated on the multilayer thus obtained after 15 minutes of stabilization at 5° C.

A result of 20 N/cm is obtained.

### Examples 1 and 2 (According to the Invention)

The hot-melt pressure-sensitive adhesive composition of Example A is reproduced, adding to its ingredients the zeolite Abscents® 2000, the contents of ingredients being indicated in the table.

The same MFI value and the same results for the forces of first and second opening by peeling at 5° C. are obtained.

The average notes obtained for the tests of evaluation of the impairment of the taste of butter and chocolate are indicated in the table.

A strong reduction in the impairment of the taste relative to the reference composition of Example A is globally observed.

### Examples 3 and 4 (Comparative)

The compositions of Examples 1 and 2 are reproduced, respectively, replacing the zeolite Abscents® 2000 with the zeolite Abscents® 3000, which is a hydrophobic zeolite available from the company UOP, the Si/Al mole ratio of which is greater than 2000.

The same MFI value and the same results for the forces of first and second opening by peeling at 5° C. are obtained.

The average notes obtained for the tests of evaluation of impairment of the taste of butter and chocolate are indicated in the table and are globally markedly superior to those obtained, respectively, for Examples 1 and 2.

### Examples 5 and 6 (Comparative)

The compositions of Examples 1 and 2 are reproduced, respectively, replacing the zeolite Abscents® 2000 with the zeolite Siliporite® G5PTC, which is a hydrophilic zeolite available from the company Arkema.

The same MFI value and the same results for the forces of first and second opening by peeling at 5° C. are obtained.

The average notes obtained for the tests of evaluation of impairment of the taste of butter and chocolate are indicated in the table and are globally markedly superior to those obtained, respectively, for Examples 1 and 2.

### Examples 7 and 8 (Comparative)

The compositions of Examples 1 and 2 are reproduced, respectively, replacing the zeolite Abscents® 2000 with the zeolite Siliporite® LSX ST, which is a hydrophilic zeolite available from the company Arkema.

The same MFI value and the same results for the forces of first and second opening after peeling at 5° C. are obtained.

The average notes obtained for the tests of evaluation of impairment of the taste of butter and chocolate are indicated in the table and are globally markedly superior to those obtained, respectively, for Examples 1 and 2.

| | TABLE | | | | | | | | |
|---|---|---|---|---|---|---|---|---|---|
| | Content in % | | | | | | | | |
| | Ex. A | | | Ex. 3 | Ex. 4 | Ex. 5 | Ex. 6 | Ex. 7 | Ex. 8 |
| Ingredient | (ref.) | Ex. 1 | Ex. 2 | (comp.) | (comp.) | (comp.) | (comp.) | (comp.) | (comp.) |
| Kraton ® D1113BT | 59.7 | 59.1 | 58.5 | 59.1 | 58.5 | 59.1 | 58.5 | 59.1 | 58.5 |
| Escorez ® 1310 LC | 24.9 | 24.6 | 24.4 | 24.6 | 24.4 | 24.6 | 24.4 | 24.6 | 24.4 |
| Dercolyte ® S115 | 14.9 | 14.8 | 14.6 | 14.8 | 14.6 | 14.8 | 14.6 | 14.8 | 14.6 |
| Abscents ® 2000 | — | 1 | 2 | — | — | — | — | — | — |
| Abscents ® 3000 | — | — | — | 1 | 2 | — | — | — | — |
| Siliporite ® G5PTC | — | — | — | — | — | 1 | 2 | — | — |
| Siliporite ® LSX ST | — | — | — | — | — | — | — | 1 | 2 |
| Irganox ® 1010 | 0.5 | 0.5 | 0.5 | 0.5 | 0.5 | 0.5 | 0.5 | 0.5 | 0.5 |
| Impairment of the taste | 3.0 | 1.6 | 1.0 | 1.8 | 3.0 | 2.4 | 2.6 | 2.7 | 3.0 |
| of butter | | | | | | | | | |
| Impairment of the taste | 2.7 | 1.5 | 0.3 | 2.0 | 2.3 | 2.5 | 1.9 | 2.7 | 2.7 |
| of chocolate | | | | | | | | | |

1. A hot-melt pressure-sensitive adhesive composition having a melt flow index (or MFI) ranging from 0.01 to 100 g/10 minutes and comprising:
from 40% to 70% of a mixture a) of styrene block copolymers comprising at least one elastomeric block, this mixture a) consisting of:
from 30% to 90% by weight of at least one diblock copolymer chosen from the group comprising SI, SBI, SIB, SB, SEB and SEP, and
from 10% to 70% by weight of at least one triblock copolymer chosen from the group comprising SIS, SIBS, SBS, SEBS and SEPS;
the total content of styrene units in said mixture a) ranging from 10% to 40% by weight;
from 25% to 55% of one or more tackifying resins b) with a softening point of between 5 and 140° C.; and
from 0.1% to 5% of a hydrophobic zeolite c) consisting of a hydrated aluminosilicate of an alkali metal or alkaline-earth metal in which the Si/Al mole ratio is in the range from 5 to 1000;
the percentages of ingredients a), b) and c) being expressed by weight and relative to the total weight of the pressure-sensitive adhesive composition.

2. The composition as claimed in claim 1, characterized in that the content of diblock in mixture a) may range from 50% to 80%.

3. The composition as claimed in claim 1, characterized in that a) is a mixture of an SIS triblock copolymer and of an SI diblock copolymer.

4. The composition as claimed in claim 1, characterized in that the tackifying resin b) has a weight-average molar mass M_{w} of between 300 and 5000 Da and is chosen from:
(i) rosins of natural or modified origin, for instance rosin extracted from pine gum, wood rosin extracted from tree roots and derivatives thereof that have been hydrogenated, dehydrogenated, dimerized, polymerized or esterified with monoalcohols or polyols such as glycerol;
(ii) resins obtained by hydrogenation, polymerization or copolymerization (with an aromatic hydrocarbon) of unsaturated aliphatic hydrocarbon mixtures containing about 5, 9 or 10 carbon atoms derived from petroleum fractions;
(iii) terpene resins generally resulting from the polymerization of terpene hydrocarbons, for instance monoterpene (or pinene) in the presence of Friedel-Crafts catalysts, optionally modified via the action of phenols;
(iv) copolymers based on natural terpenes, for example styrene/terpene, α-methylstyrene/terpene and vinyltoluene/terpene.

5. The composition as claimed in claim 4, characterized in that the tackifying resin b) is an aliphatic resin belonging to category (ii) or (iii).

6. The composition as claimed in claim 1, characterized in that the Si/Al mole ratio of zeolite c) is between 5 and 100.

7. The composition as claimed in claim 1, characterized in that zeolite c) consists of a hydrated sodium aluminosilicate.

8. The composition as claimed in claim 1, characterized in that it comprises:
from 50% to 65% of the mixture a) of styrene block copolymers,
from 30% to 50% of tackifying resin b), and
from 0.5% to 4% of hydrophobic zeolite c).

9. The composition as claimed in claim 1, characterized in that it is in the form of granules between 1 and 10 mm in size.

10. A multilayer film comprising two thin layers of thermoplastic material linked together by a continuous layer, characterized in that said layer has a thickness of between 7 and 300 μm and consists of the hot-melt pressure-sensitive adhesive composition as defined in claim 1.

11. The multilayer film as claimed in claim 10, characterized in that the thickness of the binding adhesive layer is between 10 and 50 μm.

12. The three-layer film as claimed in claim 10.

13. A process for manufacturing the multilayer film as defined in claim 10, characterized in that it comprises the coextrusion of the hot-melt pressure-sensitive adhesive composition with the materials of the two adjacent thin layers.

14. The manufacturing process as claimed in claim 13, characterized in that the hot-melt pressure-sensitive adhesive composition and the constituent materials of the two thin layers are fed into the coextrusion device in the form of granules between 1 and 10 mm in size.

15. The manufacturing process as claimed in claim 13, characterized in that the coextrusion is performed by film blowing.

16. A reclosable tray comprising in said tray the multilayer film as defined in claim 10.
